(19) United States
(12) Patent Application Publication
(10) Pub. No.: US 2016/0017618 A1
(43) Pub. Date: Jan. 21, 2016

(54) STANCHION SAFETY NET SUPPORT ARRAY WITH ANCHORAGE SYSTEM AND METHOD OF USING THE SAME

(71) Applicant: L.G. WHITE SAFETY CORPORATION, Schenectady, NY (US)

(72) Inventors: Lawrence G. White, Wright, NY (US); Mathew E. White, Wright, NY (US); Randy A. White, Wright, NY (US)

(21) Appl. No.: 14/802,201

(22) Filed: Jul. 17, 2015

Related U.S. Application Data
(60) Provisional application No. 62/026,518, filed on Jul. 18, 2014.

(51) Int. Cl. E04G 21/32; F16M 13/02; B64F 5/00

(52) U.S. Cl. CPC E04G 21/3266; B64F 5/0081; F16M 13/02

(57) ABSTRACT

A safety net support system is provided. The system includes a plurality of support members having a material positioned there between to create a barrier between neighboring support members. The system further includes a pneumatic anchorage member functionally coupled to a source of pressurized air. An anchorage member is configured to sustain a corresponding support member. Each anchorage member includes a vacuum cup and a control input that can transition the anchorage member between an engaged state and a disengaged state. In the engaged state, the anchorage member utilizes the pressurized air to establish a vacuum between the vacuum cup and a surface in contact with the vacuum cup. In the disengaged state, the anchorage member utilizes the pressurized air to establish an air cushion between the vacuum cup and the surface.

### CROSS REFERENCE TO RELATED APPLICATION[S]

This application claims priority to U.S. Provisional Patent Application to White et al., entitled “STANCHION SAFETY NET SUPPORT ARRAY WITH ANCHORAGE SYSTEM AND METHOD OF USING THE SAME,” Ser. No. 62/026,518, filed Jul. 18, 2014, the disclosure of which is hereby incorporated entirely herein by reference.

### BACKGROUND

1. Technical Field

This disclosure relates generally to safety net structures and, in particular, to an anchorage system that may be used in conjunction with stanchion-based, safety-net support systems and arrays.

2. State of the Art

Where workers on a work site are exposed to vertical drops of four feet or more, the Occupational Safety & Health Administration (OSHA) and Air Force Occupational Safety and Health Standard (AFOSH) may require that employers provide fall protection in one of three ways before work begins: (1) placing guardrails around the potential hazard; (2) installing safety nets around the potential hazard; and/or (3) providing personal fall arrest systems for each employee. Obviously, these various safety systems are employed to provide passive or active fall protection for workers performing tasks at the elevated, and therefore innately hazardous, work site.

Safety systems comprised of personal fall arrest systems attach to individual workers and prevent their precipitous fall on an individual level, whereas debris containment liners can (i.e., safety nets) encircle the work area with a fall arrest barrier that will keep workers safe should they fall or prevent them from falling off a structure. These safety nets are generally suspended over or between trusses, cantilevered supports and the like in order to provide a safety catch or stop for falling employees or dropped or falling items.

On the other hand, guardrails or perimeter safety net systems, that with which the following disclosure is concerned, are provided primarily to keep workers away from hazardous edges and prevent them from ever falling from precipitous places such as buildings or geological ledges, superstructures and, particularly in the present disclosure, aircraft surfaces.

As an illustrative example, U.S. Pat. No. 5,653,308 to White discloses a perimeter safety net support assembly of multiple, fixable posts. Each post consists in a stanchion that is fixed by welding, or bolted with braces, for support to a base crosspiece. The base crosspiece is an elongate angle iron that is bolt-able to a surface for fixation, or constrainable by straps having hooked ends. A safety net or guardrail may be coupled to the posts to establish a safety barrier there between.

However, White's safety barrier is somewhat limited, in that each crosspiece must be bolted down to the surface on which it rests, or must otherwise be secured by straps that are capable of hooking to the surface on which the crosspiece rests. In other words, due to the requirement that the crosspiece is bolted, or otherwise strapped, to the surface, White's posts have a relatively limited number of positions in which they may be arranged on the surface.

Moreover, should White's guardrail need to be moved or repositioned, extensive effort must be exerted to first determine what configuration may be attainable based on where the crosspiece is capable of being secured on the structure and to thereafter secure the crosspiece to the structure and reattach the guardrail. Such effort consumes man hours that could have otherwise been used to complete the job at hand. Further still White's system must have a separate attachment design for each style structure.

It would therefore be advantageous to the related art to develop an anchorage system that addresses the concerns described above. The following disclosure addresses these matters in greater detail.

### SUMMARY

The present disclosure relates generally to a safety net structure and, particularly, to a vacuum anchorage system that may be used in conjunction with stanchion safety net support systems and arrays.

An aspect of the present disclosure includes a safety net support system comprising: a plurality of support members; a material coupled to the plurality of support members, wherein the support members supports the material between the support members; and an anchorage member coupled to each support member, the anchorage member having configured thereon a sealing member, the sealing member being configured to transition between an engaged state and a disengaged state, wherein in the engaged state the sealing member is pneumatically coupled to a surface in contact therewith, and wherein in the disengaged state the sealing member is released from the surface.

Another aspect of the present disclosure includes a pneumatically-powered vacuum anchor comprising: a pressurized air connector configured to receive a positive compressed air supply; a control input operably coupled to the air supply, the control input having a first operating position and a second operating position, the control input being biased in the first operating position; a pneumatic sealing member operably coupled to the air supply, the pneumatic sealing member being configured to transition between an engaged state and a disengaged state, a vacuum generator operably coupled to the control input and configured to receive the air supply with the control input in the first operating position, the vacuum generator configured to place the pneumatic sealing member in the engaged state; a release valve operably coupled to the control input and configured to receive the air supply with the control input in the second operating position, the release valve configured to place the pneumatic sealing member in the disengaged state; wherein in the engaged state the sealing member is pneumatically coupled to a surface in contact therewith, and in the disengaged state the pneumatic sealing member is disengaged from the surface.

Another aspect of the present disclosure includes a method of setting a safety net support system, the method comprising: providing a plurality of support members on a surface; detachably coupling a barrier between the plurality of support members; extending the barrier between the plurality of support members such that the barrier contacts the surface and rises a length above the surface; pneumatically coupling the plurality of support members to the surface; monitoring the pneumatic coupling; and automatically maintaining the pneumatic coupling.

The foregoing and other features, advantages, and construction of the present disclosure will be more readily apparent and fully appreciated from the following more detailed description of the particular embodiments, taken in conjunction with the accompanying drawings.

### BRIEF DESCRIPTION OF THE DRAWINGS

Some of the embodiments will be described in detail, with reference to the following figures, wherein like designations denote like members:

FIG. 1A is a perspective view of an embodiment of a safety net support system on a surface in accordance with the present disclosure;

FIG. 1B is a perspective view of an embodiment of a safety net support system on a surface in accordance with the present disclosure;

FIG. 2 is a partial perspective view of an embodiment of a safety net support system in accordance with the present disclosure;

FIG. 3 is a partial, close-up perspective view of an embodiment of a safety net support system in accordance with the present disclosure;

FIG. 4 is a side view of an embodiment of a safety net support system in accordance with the present disclosure;

FIG. 5 is a schematic view of an embodiment of an anchorage component of an embodiment of a safety net support system in accordance with the present disclosure;

FIG. 6 is a perspective view of an embodiment of an anchorage component of an embodiment of a safety net support system in accordance with the present disclosure;

FIG. 7 is a side view of an embodiment of an anchorage component of an embodiment of a safety net support system in accordance with the present disclosure;

FIG. 8 is a top view of an embodiment of an anchorage component of an embodiment of a safety net support system in accordance with the present disclosure;

FIG. 9 is a perspective view of an embodiment of an anchorage component of an embodiment of a safety net support system in accordance with the present disclosure; and

FIG. 10 is a perspective view of an embodiment of an anchorage component and one or more support members of the safety net support system coupled thereto in accordance with the present disclosure.

### DETAILED DESCRIPTION OF EMBODIMENTS

A detailed description of the hereinafter described embodiments of the disclosed apparatus and method are presented herein by way of exemplification and not limitation with reference to the Figures listed above. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

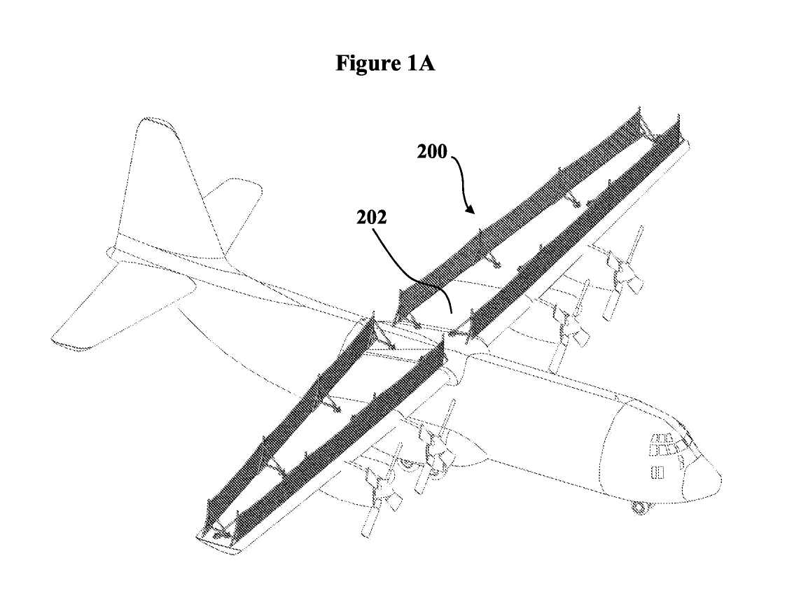

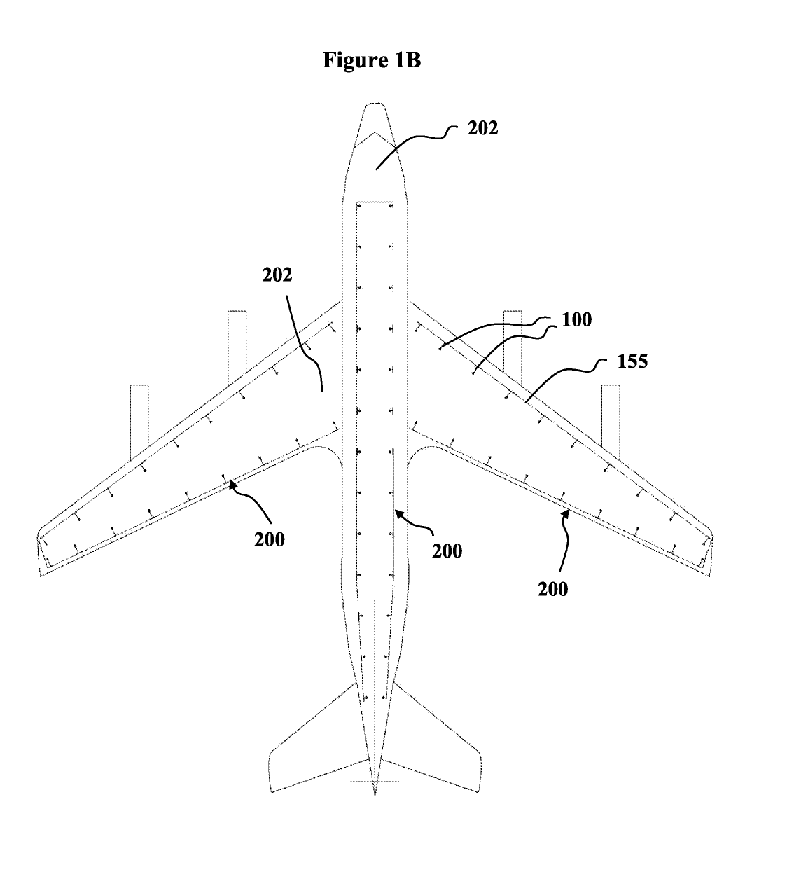

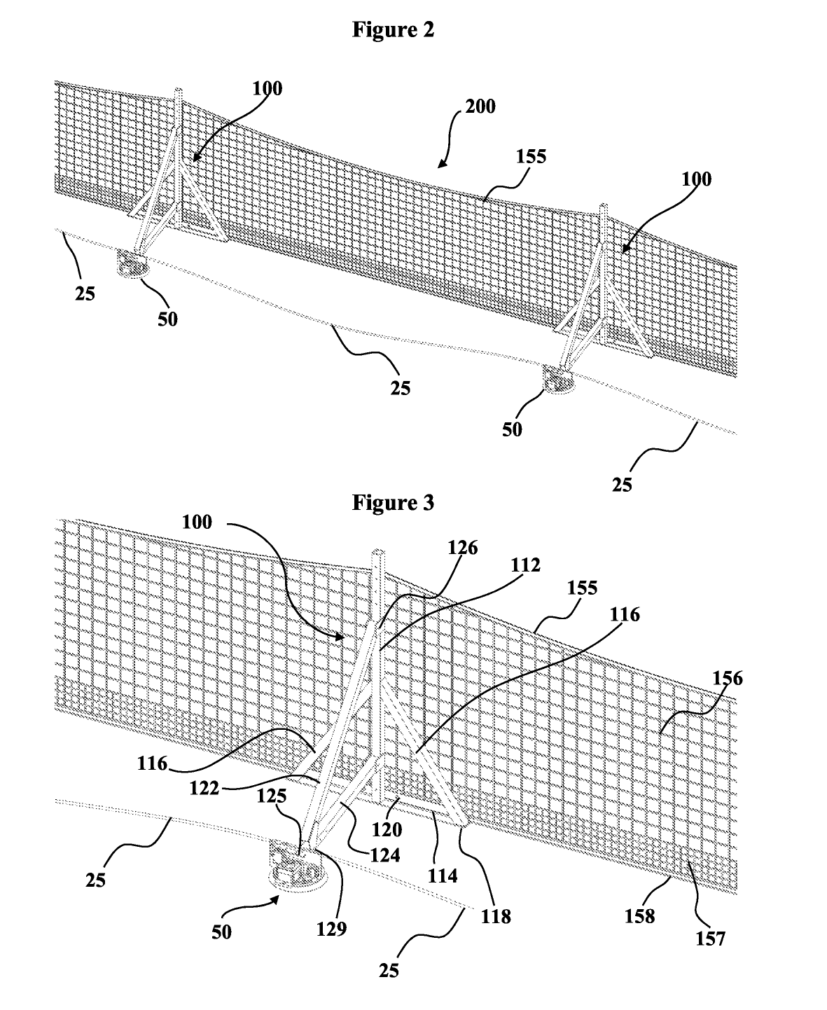

Referring to the drawings, FIGS. 1A and 1B depict an exemplary embodiment of a safety net support system 200 on a surface 202, such as an aircraft fuselage surface and/or a wing surface. FIGS. 2 and 3 depict an embodiment of a safety net support system 200 deployed on a surface, the safety net support system 200 having a support member 100 and an anchorage system/apparatus 50 incorporated therein. Embodiments of the support member 100 and the anchorage system 50 may each comprise various structural and functional components that complement one another to provide the unique functionality and performance of the safety net support system 200, support member 100, and the anchorage system 50, the structure and function of which will be described in greater detail herein.

With reference to FIGS. 2-4, embodiments of the support member 100 may comprise an upright member 112 that serves as the “stanchion” of the support member 100 and a crosspiece member 114 as the “stanchion base” of the support member 100. Hereinafter, the terms “upright member” and “stanchion,” as well as “crosspiece member” and “stanchion base,” may be used interchangeably throughout the disclosure. The stanchion base 114 may be an angle of elongate structure. The stanchion 112 may be detachably coupled to the stanchion base 114 at a point of the stanchion base 114 between opposing distal ends of the stanchion base 114. Alternatively, the stanchion 112 may be rotatably coupled to the stanchion base 114. Alternatively, the stanchion 112 may be fixedly coupled to the stanchion base 114. The stanchion base 114 may be optionally connected to the stanchion 112 with additional braces 116 (or brace structure), to provide greater rigidity and strength to the stanchion 112 if the various parts are to be bolted together rather than welded. A pad 118 may underlie the crosspiece (base) 114 to protect surfaces such as airframes or finished substrates. A series of holes 120 in the crosspiece 114 may be provided for facilitating hook or similar device (not shown) engagement of the stanchion 112 to a surface, such as, for example, an aircraft fuselage or wing. Further, one or more tethering hooks 121 may be coupled to the stanchion 112 or crosspiece 114 to facilitate coupling of a barrier 155 to the stanchion 112 or crosspiece 114, as the case may be. The barrier 155 may be, for example, a material, textile, fabric, netting, web, net, mesh, fence, string, rope, chain, wall, boundary or other similar border-creating material or structure. The barrier 155 may further comprise a plurality of netting patterns, or at least a first and second netting pattern, wherein the first netting pattern 156 may have a particular weave/pattern and interval between the weave/pattern and the second netting pattern 157 may have a particular weave/pattern and interval between the weave/pattern that is smaller than the interval of the first netting pattern. For example, and not in any way limiting, the first netting pattern 156 may have an interval of between 1″ to 2″ or more, whereas the second netting pattern 157 may have an interval of between ¼″ to ½″ or less. Additionally, the barrier 155 may have a lower edge surface 158 that is configured to contact the surface of the aircraft fuselage or wing to establish a physical barrier between a worker on the aircraft and the edges of the aircraft. As such, the barrier 155 may serve as a protective wall or fence to prevent a worker from falling off of the edges of the aircraft, or other large surface on which the safety net support system 200 is deployed and utilized. In fact, for further safety, the barrier 155 may be configured such that the second netting pattern 157 resides in the barrier 155 near the edge of the barrier 155 that is intended to make contact with the surface. In this way, the second netting pattern 157, having the tighter weave interval, may prevent tools and other smaller objects from rolling or falling off the elevated surface on which the safety net support system 200 is deployed. The tighter weave interval may be configured to prevent these relatively smaller objects from passing through the barrier 155, whereas the larger netting interval of the first netting pattern 156 may be sufficient to prevent workers or other relatively large objects from falling off the elevated surface on which the safety net support system 200 is deployed. Additionally, to provide further safety, the barrier 155 may be configured to couple to and be supported by one or more support members 100 of the plurality of support members 100. Indeed, the barrier 155 in some embodiments may be configured to couple to and be supported by each of the support members 100 of the plurality of support members 100. With the barrier 155 supported by the support members 100, the bottom or base edge of the barrier 155 may contact most, if not all, of the surface on which the safety net support system 200 is deployed. At the very least, the bottom or base edge of the barrier 155 may contact a substantial portion of the surface, between each of the support members 100, on which the safety net support system 200 is deployed.

Embodiments of the safety net support member 100 may comprise an upper arm 122 and a lower arm 124 that may each be coupled to the stanchion 112 at their respective pivotal (or hinged) mechanisms 126 and 128. A distal end or lower portion of upper arm 122 may be functionally engaged at pivotal mechanism 129 to the lower arm 124 in one of a plurality of holes 130 along the lower arm 124. A distal end or lower portion of the lower arm 124 may be functionally engaged at pivotal connection 125 to the anchorage system 50, to be described in greater detail herein. As an alternative to being bolted to one another, or otherwise being functionally coupled to one another by other known coupling means, the stanchion 112, crosspiece 114, additional braces 116, upper arm 122, and lower arm 124 may be welded to one another. Moreover, in addition to the materials listed below, the stanchion 112, crosspiece 114, additional braces 116, upper arm 122, and lower arm 124 may be comprised of aluminum or steel angle irons, beams or tubing.

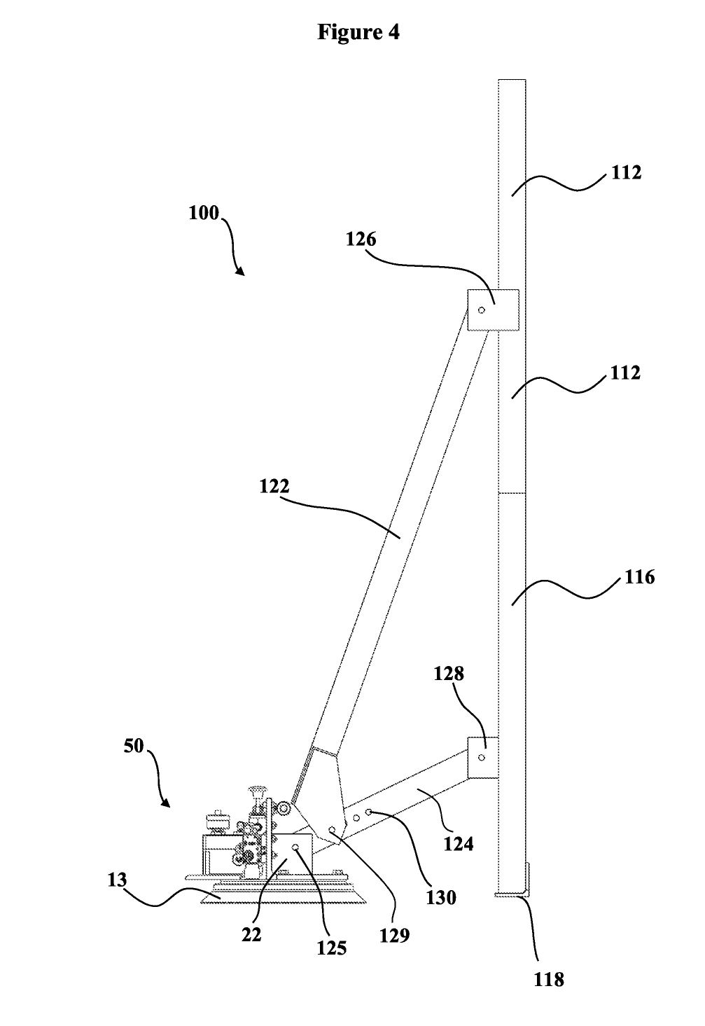

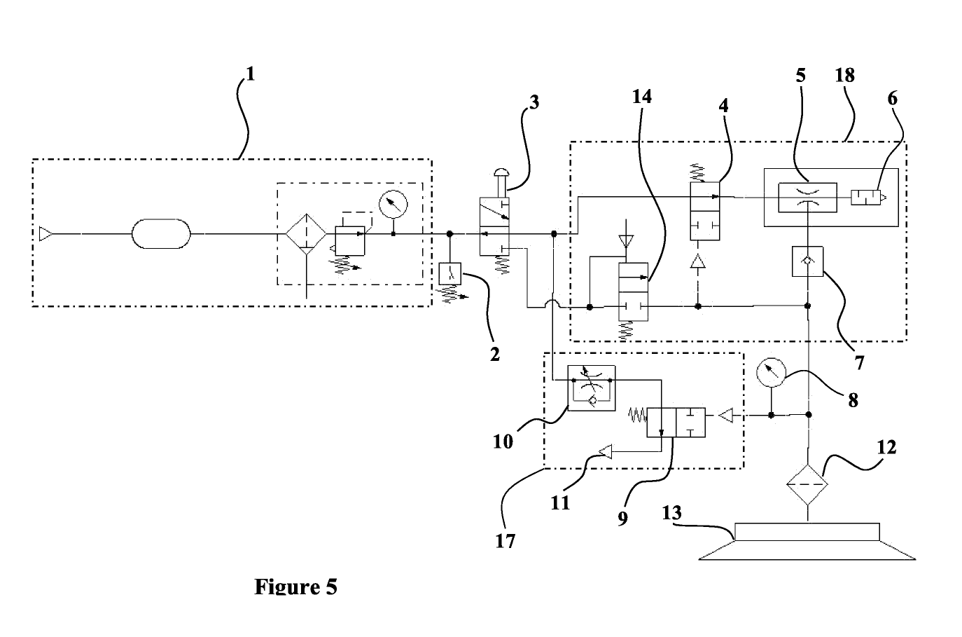

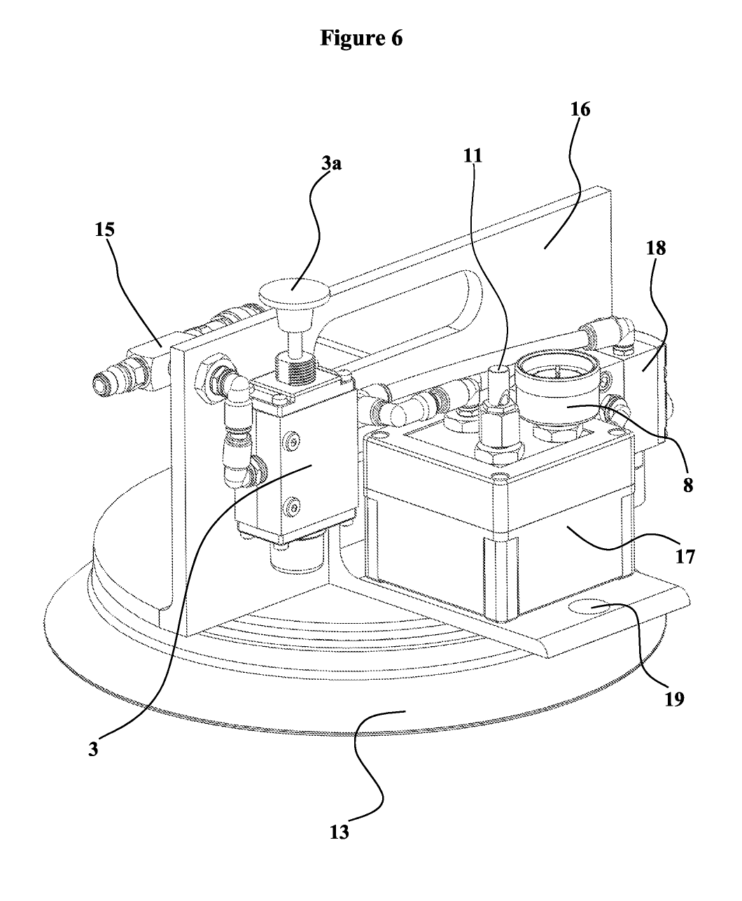

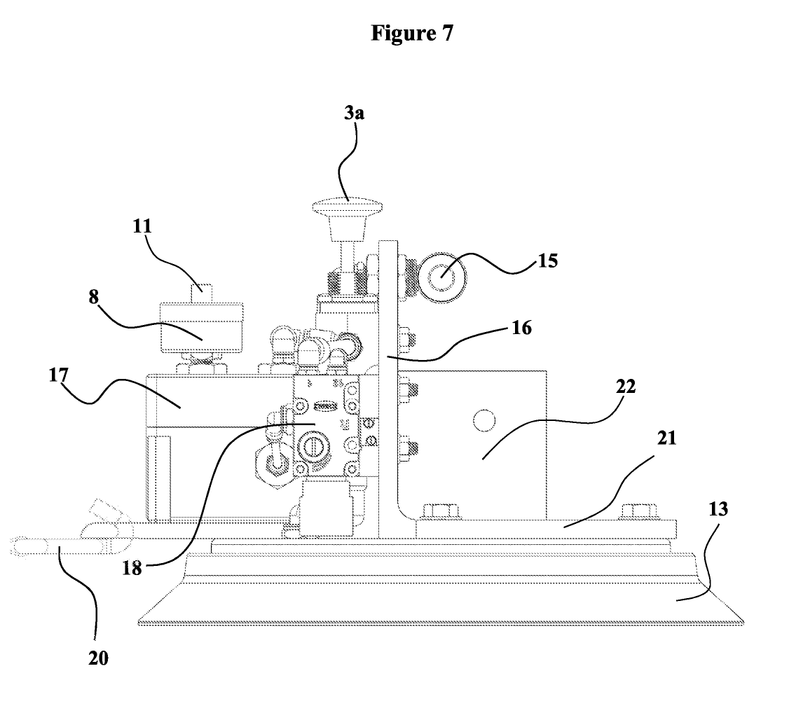

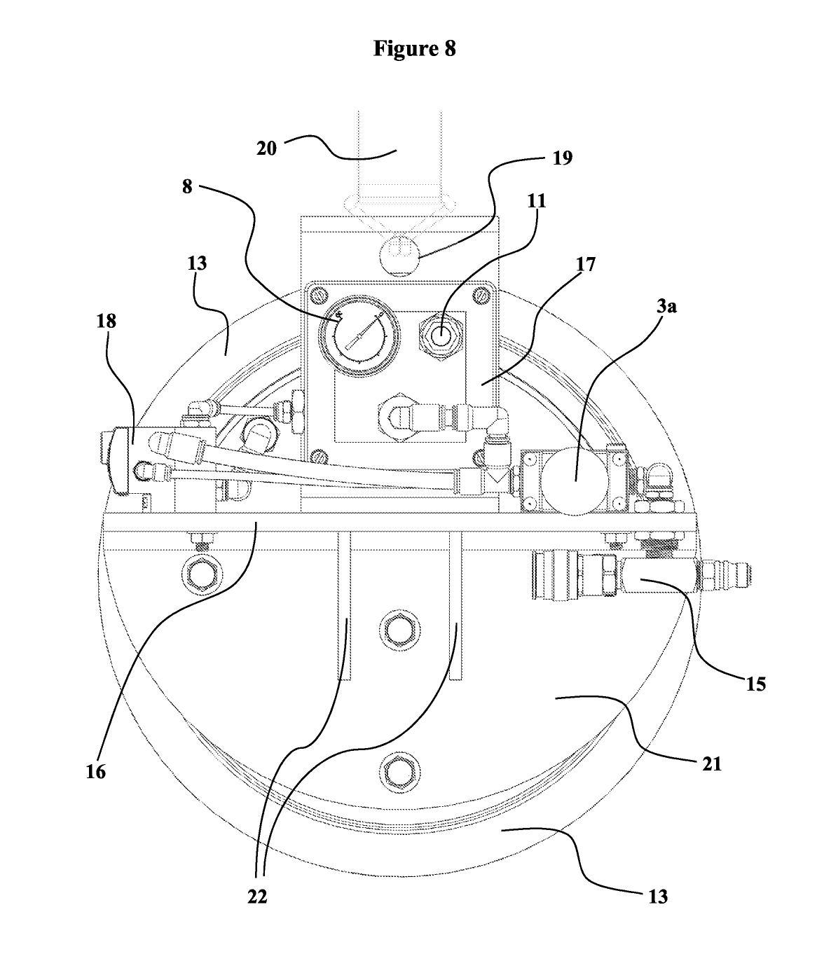

With reference to FIGS. 4-8, embodiments of the safety net support system 200 may further comprise an anchorage system/apparatus 50. The apparatus 50 may be a pneumatically-powered device. For example, the apparatus 50 may be operable by the attachment thereto of a positive compressed air supply 1. The apparatus 50 may be configured to function as a pneumatic vacuum anchor of the system 200, as will be described in greater detail herein. Moreover, the system 200 may further comprise a pressure switch 2 configured between the compressed air supply 1 and the apparatus 50. The pressure switch 2 may be configured to function as an alert, signal, or indicator to warn or otherwise recognize and alert a low pressure supply of the compressed air supply 1.

Embodiments of the apparatus 50 may comprise, among other components to be described herein, a bracket (frame) 16, one or more air pressure couplings 15, a directional control valve 3, a vacuum generator 18, a vacuum cup 13, and an alarm 11. The bracket 16 may be configured to provide a platform/stage on which the other remaining or additional components of the apparatus 50 may be coupled, housed, configured, or otherwise set forth. The bracket 16 may further comprise a handle, grip, clasp, or other structure that allows for a user to grasp the bracket 16 to move the apparatus 50 from location to location, as needed. Exemplary embodiments of the bracket 16 may comprise a primary vertical member and a primary horizontal member, the primary vertical member and the primary horizontal member being formed from a single, integral piece of material. Alternatively, the primary vertical member and the primary horizontal member may be formed as separate pieces and fixedly coupled together by permanent fastening means, such as welding. The vertical member of the bracket 16 may be configured to have, include, define, contain, or otherwise comprise the handle, grip, clasp, or other structure that allows for a user to grasp the bracket 16. The vertical member of the bracket 16 may also be configured to support, include, or otherwise sustain additional components of the apparatus 50. The horizontal member of the bracket 16 may be configured to receive and retain thereon a mounting plate 21 and/or a vacuum cup 13, each of which will be described in greater detail herein. The horizontal member of the bracket 16 may also be configured to support, include, or otherwise sustain additional components of the apparatus 50.

Embodiments of the anchorage system/apparatus 50 may comprise an engagement member 22 that may be configured to functionally and operationally engage the lower arm 124 at the pivotal connection 125 to thereby physically, functionally, and operationally engage the apparatus 50 with the remaining portions of the safety net support array (system) 100. The engagement member 22 may be fixedly configured on the bracket 16. Alternatively, the engagement member 22 may be configured to be releasably and repeatedly coupled to the bracket 16.

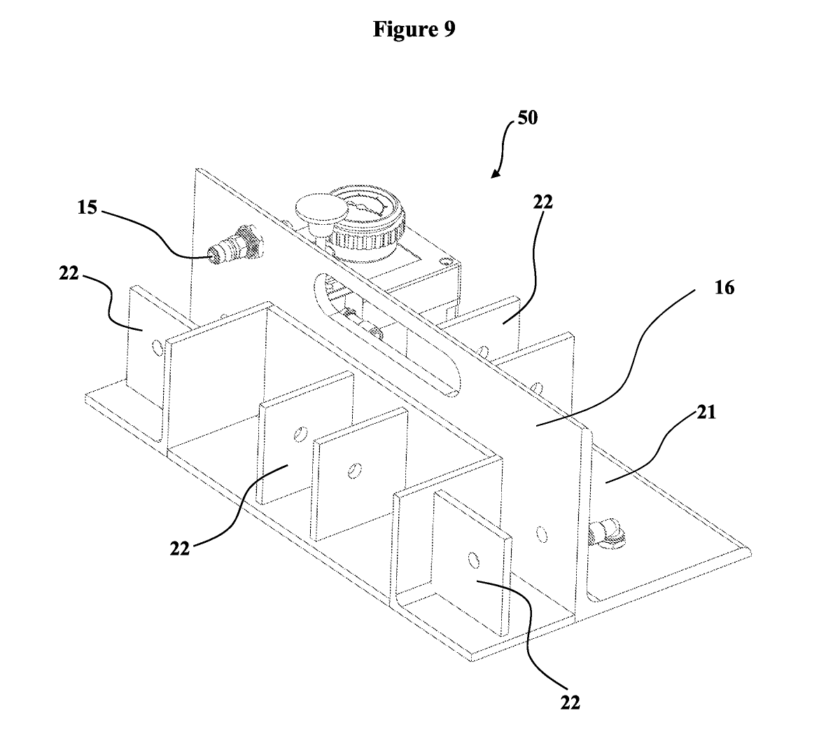

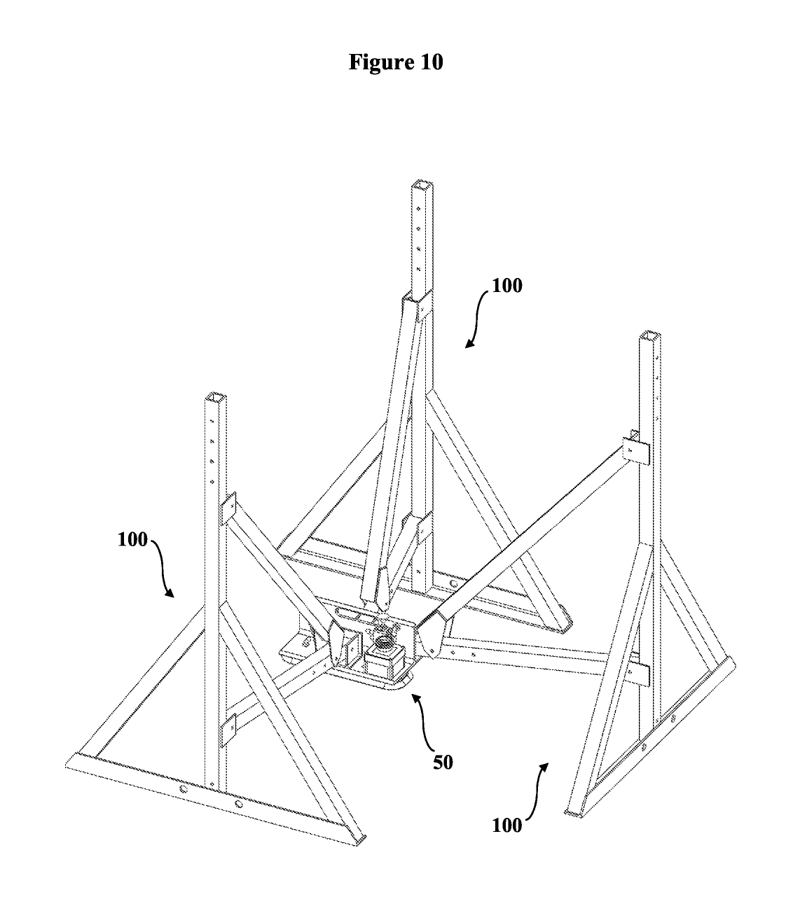

With reference to FIGS. 9 and 10, embodiments of the anchorage system/apparatus 50 may further comprise one or more engagement members 22 on the apparatus 50 or the bracket 16. Each engagement member 22 may comprise a pair of vertical members each having a hole extending through the width thereof. As such, the lower arm 124 of each support array 100 may be brought into proximity with the pair of vertical members such that the pivotal connection 125 engages or communicates with the pair of vertical members and the hole. Moreover, a pin, bolt, or other fastening member may be inserted through the pivotal connection 125 and the hole in each vertical member, such that the pin, bolt, or other fastening member functionally couples and engages the engagement member 22 to the pivotal member 125 and thus the lower arm 124. With multiple engagement members 22, the apparatus 50 may be capable of receiving and retaining a plurality of lower arms 124, each lower arm 124 being received and retained by, or otherwise coupled to, a corresponding one of the multiple engagement members 22, such that more than one support array 100 may be coupled to a single apparatus 50, as exemplarily depicted in FIG. 10. Indeed, embodiments of the apparatus 50 provide that an engagement member 22 may be provided, or otherwise configured, on all four “sides” of the bracket 16, such that each apparatus 50 may have coupled thereto a support array 100 that extends from one of the four “sides” or a plurality of the four “sides, as exemplarily depicted. It should be understood that many additional configurations over those that are shown are possible with a plurality of engagement members 22 being configured on the apparatus 50.

With reference again to FIGS. 4-8, embodiments of the anchorage system/apparatus 50 may comprise the bracket 16 being configured to receive thereon a mounting plate 21, the mounting plate 21 being configured to receive thereon and physically and functionally communicate with the vacuum cup 13, which may be, for example, a sealing member having a short-lip outer seal and cleats or channels in the bottom to allow the vacuum effect of the sealing member to be generated to the full diameter of the cup 13. The sealing member may be comprised of various materials including for example, but not limited thereto, silicone, polyurethane, fluoroelastomer, nitrile rubber (Buna-N, Perbunan, acrylonitrile butadiene rubber, or NBR). The vacuum cup 13 may be configured to be replaceable, as needed. For example, a replacement vacuum cup 13 may be configured to replace a worn-out or damaged vacuum cup 13 on the mounting plate 21. Further, the mounting plate 21 may also be configured to be replaceable, as needed. For example, a replacement mounting plate 21 may be configured to replace a worn-out or damaged mounting plate 21 on the bracket 16. Further, embodiments of the apparatus 50 may further comprise the vacuum cup 13 being configured to functionally and operationally engage the bracket 16, independent of the mounting plate 21. For example, the bracket 16 and/or vacuum cup 13 may be configured to directly engage one another to provide the unique functionality of the vacuum cup 13 described herein.

Embodiments of the anchorage system/apparatus 50 may further comprise one or more air pressure couplings 15. The air pressure coupling 15 may be configured to receive a source of pressurized air 1, such as, for example, a non-lubricated, filtered, and regulated compressed air supply from an air system, air compressor, or compressed air storage container. The air pressure coupling 15 may be a conventional quick-connect coupling that is configured to receive a corresponding male or female quick connect coupling attached to an air hose 25, the air hose 25 being configured to carry and direct the pressurized air through the hose 25 from the air source to the coupling 15. The coupling 15 may be configured with a male coupling and a female coupling, such that the coupling 15 of each apparatus 50 may be connected in series by air pressure hoses 25 running between the corresponding coupling 15 of additional apparatuses 50. In other words, when a plurality of apparatuses 50 are provided to couple with a corresponding array 100 to construct the safety net support system 200, each apparatus 50 may be connected in pneumatic series via the corresponding coupling 15 to the pressurized air supply source. As such, a single pressurized air source can pressurize and thereby control the operation of each of the plurality of apparatuses 50 in the safety net support system 200.

Embodiments of the anchorage system/apparatus 50 may further comprise the directional control valve 3. The directional control valve 3 may be configured to control the flow of pressurized air to other remaining components of the apparatus 50. For example, pressurized air may enter the directional flow valve 3 after entering the apparatus 50 via the coupling 15. Further in example, the directional flow valve 3 may be a hand-operated, 3-way, 3 port, 2 position, automatic spring return, ¼ NPT, control valve having an operational input control, such as a palm button. The directional flow valve 3 may be an input control and may operate between a first position and a second position and/or between an engaged state and a disengaged state. The directional flow valve 3 may further comprise an actuator 3a that may be configured to transition the directional flow valve 3 between the first and second positions. For example, pressing down on the actuator 3a may transition the directional flow valve 3 from the first position to the second position.

The first position of the directional control valve 3 may be the default setting that allows pressurized air flow between ports 2 and 3 so that compressed or pressurized air may pass through the valve 3 and into an air actuated valve 4, which is part of the vacuum generator 18. The valve 4 may function to control the input of pressurized gas and/or air into the vacuum generator 18, which creates the suction effect between the vacuum cup 13 and the surface on which the vacuum cup 13 rests. Alternatively, by activating the input control on the control valve 3, such as the palm button, the control valve 3 may be transitioned from the first position to the second position. In the second position, port 3 is blocked and allows airflow between ports 1 and 2, which directs the flow of compressed or pressurized air to flow to an air actuated valve 14 that controls the blow-off function of the vacuum generator 18 that releases the suction between the vacuum cup 13 and the surface. The details of such operation will be discussed in greater detail herein.

The vacuum generator 18 discussed above may comprise a single or multistage venturi vacuum 5 that is configured to utilize the pressurized air received through the valve 4 to create a negative pressure between the vacuum cup 13 and the surface on which the cup 13 is placed. In other words, with the valve 3 in the default or first position, the pressurized air flows to and through the valve 4 and enters the venturi vacuum 5, which is configured to exhaust air from between the vacuum cup 13 and the surface on which the cup 13 is placed to the atmosphere to create a suction between the cup 13 and the surface to thereby adhere the cup 13 to the surface. With the suction generated between the vacuum cup 13 and the surface, the apparatus 50 is placed in an engaged state.

The operation of the vacuum generator 18 may further comprise a silencer 6 that is operatively coupled to the venturi vacuum 5 to muffle the air that exits the venturi vacuum 5 to the atmosphere. Once a predetermined vacuum level (i.e., negative pressure level or suction level) is reached between the vacuum cup 13 and the surface, the pneumatic air saving function engages or activates the valve 4 to restrict, stop, or otherwise shut-off the flow of compressed air through the valve 4 to the venturi vacuum 5, such that the venturi vacuum 5 ceases to exhaust air from between the vacuum cup 13 and the surface. Moreover, operation of the vacuum generator 18 further comprises a non-return valve 7 that is positioned between the venturi vacuum 5 and the vacuum cup 13 to allow one-directional flow of air from the vacuum cup 13 to the venturi vacuum 5 to hold the vacuum effect in the system between the vacuum cup 13 and the surface when the vacuum generator 18 enters the air saving mode or the compressed air is disconnected.

As mentioned briefly above, the vacuum generator 18 further comprises the air actuated valve 14 that controls the blow-off function of the vacuum generator 18. For example, when the input control on the control valve 3, such as the palm button, is operated, the control valve 3 functions to direct the flow of pressurized air to valve 14. Valve 14 is configured to receive the pressurized air from valve 3 and open in response thereto to permit the flow of pressurized air to pass through valve 14 and to the vacuum cup 13 to create an air cushion between the vacuum cup 13 and the surface. In other words, once the pressurized air flows through the valve 14 and reaches the vacuum cup 13, the vacuum effect, or suction, between the vacuum cup 13 and the surface is released, or otherwise terminated, and the apparatus 50 is placed in a disengaged state, wherein the apparatus 50 may be moved along the surface without the vacuum cup 13 attempting to adhere to the surface. The release of the vacuum cup 13 from the surface is accomplished at an accelerated, pneumatically-powered rate, such that it is almost instantaneous with the operation of the control valve 3. Moreover, the air cushion created between the vacuum cup 13 and the surface when the control valve 3 is operated and the valve 14 is open provides for quick and efficient maneuvering of the apparatus 50 against, along, or on top of the surface. Indeed, the air cushion created by the introduction of the pressurized air between the vacuum cup 13 and the surface substantially supports the weight of the apparatus 50 so that a user may quickly and efficiently reposition the apparatus 50 to a desired point on the surface without fighting the weight of the apparatus 50. In other words, the air cushion is configured to support the weight of the apparatus 50 against the force of gravity such that the air cushion more or less eliminates the effects of friction between the vacuum cup 13 and the surface so that the user need only apply lateral force to maneuver the apparatus 50 along the surface.

Accordingly, embodiments of the apparatus 50 may comprise the first position or default position of the control valve 3 placing the apparatus 50 in the engaged state and the second position of the control valve 3 placing the apparatus 50 in the disengaged state.

In addition to the above, once the input control on the control valve 3 is released by the user, the control valve 3 may be configured to automatically return to the first position or default position. As described above, with the valve 3 in the default or first position, the pressurized air flows to and through the valve 4 and enters the venturi vacuum 5, which is configured to exhaust air to the atmosphere from between the vacuum cup 13 and the surface on which the cup 13 is placed, which thereby creates a suction between the cup 13 and the surface to thereby adhere the cup 13 to the surface. Then again, once the input control is operated by the user, the control valve 3 is transitioned to the second position, which places the apparatus 50 in the disengaged state. The valve 3 (i.e., input control) may be operated any number of times to quickly, efficiently, and easily transition the apparatus 50 between the engaged state and the disengaged state, as desired by the user.

Embodiments of the anchorage system/apparatus 50 may further comprise a pressure monitoring system 17. The pressure monitoring system 17 may comprise an alarm 11, a pneumatic vacuum switch 9, and air flow control valve 10. The alarm 11 may be, for example, any device that generates a warning to the user that the vacuum affect, or suction, is below a required or predetermined level. The alarm 11 may be a pneumatic air powered whistle that audibly indicates an insufficient vacuum between the vacuum cup 13 and the surface. As an illustrative example, the flow of pressurized air may flow into the air flow control valve 10 that is configured to regulate the pressurized air flow in the flow-control direction (inlet to outlet) and permits air flow freely in the other direction. The air flow control valve 10 also permits the pressurized air flow to enter the pneumatic vacuum switch 9 that is configured to operate the alarm 11. The vacuum switch 9 is normally open when there is insufficient vacuum within the system. With the vacuum switch 9 open, the pressurized air may reach the alarm 11 to flow through the alarm 11 and thereby warn the user that insufficient vacuum is present. Once a sufficient or predetermined vacuum level is achieved within the system, the vacuum switch 9 closes and restricts, stops, or otherwise shuts off the flow of pressurized air to the alarm 11. Accordingly, upon start up or between the time it takes for the apparatus 50 to connect to the pressurized supply of air and for the predetermined vacuum level to be achieved, the vacuum switch 9 may sound the alarm 11. However, once the predetermined vacuum level is achieved (by way of the valve 4 and the venturi vacuum 5 discussed above), the vacuum switch 9 closes and the alarm 11 goes silent. Yet, should the vacuum level between the vacuum cup 13 and the surface thereafter drop below the predetermined level, the vacuum switch 9 can reopen and cause the alarm to sound. Additionally, at the same time, the valve 4 can also measure, or otherwise sense the drop in vacuum level between the vacuum cup 13 and the surface below the predetermined vacuum level and permit pressurized air to flow through the valve 4 and to the venturi vacuum 5 to cause the venturi vacuum 5 to increase the vacuum level between the vacuum cup 13 and the surface back above the predetermined or acceptable vacuum level. Once the vacuum level is reestablished above the predetermined vacuum level, the valve 4 may close to stop the venturi vacuum 5 from increasing the vacuum level and the vacuum switch 9 may close to stop or silence the alarm 11. In this way, the vacuum level is monitored by the apparatus 50, warns the user that the vacuum level has fallen below the predetermined acceptable vacuum level by sounding the alarm 11, automatically readjusts the vacuum level above the predetermined level, and thereafter ceases the warning.

With respect to vacuum level, it will be apparent to those of ordinary skill in the art that any reference to a predetermined vacuum level and the various components of the apparatus 50 functioning to maintain the vacuum level between the vacuum cup 13 and the surface above the predetermined vacuum level is likewise a reference to a predetermined pressure level and the various components of the apparatus 50 functioning to maintain the pressure level between the vacuum cup 13 and the surface below the predetermined pressure level. Such a reference is understood by those of ordinary skill in the art because, with regard to pressure terms in general, low pressure is equivalent to high vacuum and vice versa. In other words, a high vacuum pressure may maintain a vacuum effect between the vacuum cup 13 described herein and the surface, while at the same time a low pressure may maintain a vacuum effect between the vacuum cup 13 described herein and the surface. As such, and as described herein in greater detail, the apparatus 50 may be configured to maintain a vacuum level between the vacuum cup 13 and the surface above a predetermined vacuum level and may be configured to maintain a pressure level between the vacuum cup 13 and the surface below a predetermined pressure level.

The above-described automated vacuum warning and regeneration process may be repeated time and time again during operation of the apparatus 50, so long as the apparatus 50 is coupled to the pressurized supply of air. If on the other hand, the apparatus 50 has been operated to bring the vacuum level above the predetermined level and is thereafter disconnected from the pressurized supply of air, the apparatus 50 is nevertheless equipped to sound the warning of the alarm 11 when the vacuum level falls below the acceptable threshold despite not being able to regenerate the vacuum level to above the acceptable threshold.

In addition to the alarm 11, embodiments of the anchorage system/apparatus 50 may further comprise a visual indicator 8, such as a vacuum gauge or a pressure gauge, for visually indicating the vacuum level or pressure level to the user. The visual indicator 8 may be configured on the apparatus to measure the vacuum level (i.e., pressure level, or lack thereof) between the vacuum cup 13 and the surface and to provide a visual measure of the actual vacuum level of the apparatus 50 to the user. Embodiments of the anchorage system/apparatus 50 may further comprise the visual indicator 8 being one of a vacuum gauge that measures vacuum pressure or a pressure gauge that measures pressure levels. Those of ordinary skill in the art understand that low pressure is equivalent to high vacuum and vice versa. As such, the pressure level measured by the visual indicator 8 or other components herein, such as the pressure monitoring system 17, may be configured to measure the vacuum pressure or the low pressure.

Embodiments of the anchorage system/apparatus 50 may further comprise a vacuum filter 12. The vacuum filter 12 may be configured in the apparatus 50 to filter the air being evacuated from between the vacuum cup 13 and the surface. The filter 12 may function to keep debris and other contaminants from entering the operating components of the system, such as the vacuum generator 18, for example.

Embodiments of the anchorage system/apparatus 50 may further comprise a coupling point 19 that may be configured to physically and functionally engage a strap 20. The strap 20 may be configured with a hook end that can functionally engage the coupling point 19, such that the force exerted on the strap 20 may be physically transferred to the apparatus 50 via the coupling point 19. One or more coupling points 19 may be configured on the apparatus 50, such as the bracket 16. Each coupling point 19 may be configured to receive, retain, and functionally engage one or more straps 20.

With further reference to the Figures and the disclosure set forth above, embodiments of the safety net support system 200 may comprise a methodology of positioning, assembling, arranging, securing, manipulating, anchoring, or otherwise moving the safety net support system 200 from a stored position to an in-use position or from a first in-use position to a second in-use position, or subsequent in-use position. The methodology may comprise providing a support member, such as the support member 100, that may be releasably coupled to a surface, such as a vertical surface, horizontal surface, floor, wall, aircraft surface, etc. The methodology may further comprise providing a mesh barrier, flexible barrier, and/or net-type barrier that may be configured to releasably couple to any of the provided support members 100. The barrier, once coupled to the support member 100 at an elevated position on the support member 100 above the surface, may function as a moveable wall or barrier that extends from the base of the support member 100 (and thus effectively from the surface on which the support member 100 is positioned) to a length above the surface. Further, the methodology may further comprise arranging the barrier to extend between neighboring support members 100 to construct said wall or barrier mentioned above.

The methodology may further comprise releasably and pneumatically coupling the support member 100 to the surface. The support member 100 may comprise an anchorage member 50, having a suction component thereon such as the vacuum cup 13, that may be configured to pneumatically anchor to the surface by vacuum suction powered by compressed gas, such as air. The methodology may further comprise repeatedly sealing the anchorage member to the surface by the operation of a pneumatic air supply. The anchorage member of each support member 100 may be pneumatically coupled in series, such that each anchorage member is pneumatically coupled to a single source of compressed air. The methodology may comprise initially anchoring the anchorage member to the surface by pneumatics and thereafter monitoring the pressure level between the anchorage member and the surface. Next, the pressure level may be monitored by a pressure monitor system to ensure that the pressure level is maintained below a predetermined pressure level (or above a predetermined vacuum pressure, depending on what pressure gauges are utilized to measure the pressure). If the pressure level rises above the predetermined pressure level, the pressure monitor system may automatically activate to remove gas by vacuum from between the anchorage member and the surface to reduce the pressure below the predetermined pressure level. Once the pressure levels are placed within acceptable pressure levels or within the predetermined pressure levels, the pressure monitor system may deactivate the vacuum and place the anchorage member in a steady state, wherein the anchorage member is pneumatically anchored to the surface by pressure and the pressure is continuously monitored, as herein described. Actuating a warning signal or alarm when the pressure falls outside of acceptable levels may further comprise portions of the methodology.

The methodology may further comprise releasing the anchorage member from the surface. Releasing the anchorage member may further comprise introducing pressurized air between the anchorage member and the surface to increase the pressure therebetween and break the vacuum seal, thereby releasing the anchorage member and thus the support member 100 from the surface. Moreover, releasing the anchorage member may further comprise creating an air cushion between the anchorage member and the surface by continuously introducing pressurized air between the anchorage member and the surface, wherein the air cushion is a pneumatic layer of gas, such as air, that forcibly lifts the anchorage member off of the surface. The air cushion, or pneumatic layer of gas, may be strong enough to support the weight of the anchorage member and the support member 100 to prevent the anchorage member from making substantial contact with the surface to thereby reduce the friction therebetween and allow for the easy displacement of the anchorage member, and thus the support member 100, along the surface. In this way, each of the support members 100 may be easily moved from location to location on the surface.

The methodology may further comprise biasing a control switch, such as directional flow valve 3, on the anchorage member to a first position, wherein in the first position and with the anchorage member coupled to the pressurized air source the anchorage member may be pneumatically anchored to the surface. Actuating the control switch to a second position may pneumatically release the anchorage member from the surface. Upon release of the control switch, the control switch may automatically return to the first position and cause the anchorage member to pneumatically re-anchor to the surface and remain anchored to the surface until the control switch is actuated or until the pressurized air source is decoupled from the anchorage member.

The methodology may further comprise coupling one or more of the support members 100 to a single anchorage member, such that each of the support members 100 is anchored to the surface by the single anchorage member.

With reference to the foregoing discussion and disclosure, there is a need in the relevant industry to provide perimeter safety netting over the wing surfaces and fuselage of rather large aircraft, as depicted in the Figures. Therein is illustrated a perimeter safety net system 200, of the present disclosure, that utilizes the support member 100 together with the apparatus 50 to allow an operator or user to efficiently and quickly position, adjust, and reposition the system 200 to any point on the wing and fuselage surfaces of the aircraft, as needed. The speed and effectiveness of which the apparatus 50 may attach and detach from the surfaces of the aircraft significantly reduces the number of man hours it takes to set up, adjust, and take down the system 200, which thereby reduces the total time to job completion. Moreover, the warning systems of each apparatus 50 (i.e., alarm 11 and/or visual indicator 8) provide real-time analysis and feedback of the functional capability and structural integrity of each apparatus 50 and thereby the support system 200.

Construction of the safety net support system 200 and the safety net support array (apparatus) 100 and the accompanying anchorage system (apparatus) 50, described herein and depicted in the accompanying Figures may be had by conventional materials and fabrication methods. For example, the safety net support member 100 may employ aluminum tubing and bolting with both hardened steel and stainless steel devices. Moreover, welding is favored over bolting in cases where additional bracing, such as between crosspiece and upright (of the T-shaped stanchion) is not desired, or is to be avoided.

In addition to the foregoing, the components defining the above-described safety net support system 200 and the accompanying support member 100 and anchorage system 50 may be formed of any of many different types of materials or combinations thereof that can readily be formed into shaped objects provided that the components selected are consistent with the intended operation of a safety net support array having a vacuum anchoring system of the type disclosed herein. For example, and not limited thereto, the components may be formed of: rubbers (synthetic and/or natural) and/or other like materials; glasses, such as fiberglass, silicate glass, naturally occurring glass, or any other amorphous solid material, any combination thereof, and/or other like materials; ceramics or any other crystalline or partly crystalline material, any combination thereof, and/or other like materials; wood or any other hard, fibrous structural tissue or material, any combination thereof, and/or other like materials; carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining the above-described safety net support system 200 and the accompanying support member 100 and anchorage system 50 may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, 3-D printing, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the present disclosure, as required by the following claims. The claims provide the scope of the coverage of the present disclosure and should not be limited to the specific examples provided herein.

What is claimed is:

1. A safety net support system comprising:
a plurality of support members;
a material coupled to the plurality of support members, wherein the support members supports the material between the support members; and
an anchorage member coupled to each support member, the anchorage member having configured thereon a sealing member, the sealing member being configured to transition between an engaged state and a disengaged state,
wherein in the engaged state the sealing member is pneumatically coupled to a surface in contact therewith, and wherein in the disengaged state the sealing member is released from the surface.

2. The safety net support system of claim 1, wherein a positive compressed-air supply powers the anchorage member.

3. The safety net support system of claim 1, further comprising a control input operable between a first position and a second position, the control input being biased in the first position.

4. The safety net support system of claim 3, wherein with the control input in the first position the sealing member is in the engaged state, and wherein with the control input in the second position the sealing member is in the disengaged state.

5. The safety net support system of claim 1, wherein in the engaged state a gas between the sealing member and the surface is pneumatically vacated to fixedly couple the sealing member to the surface by vacuum.

6. The safety net support system of claim 1, wherein in the disengaged state a compressed gas is introduced between the sealing member and the surface to release the sealing member from the surface.

7. The safety net support system of claim 6, wherein in the disengaged state the compressed gas is continuously introduced between the sealing member and the surface to create an air cushion between the sealing member and the surface.

8. The safety net support system of claim 1, wherein the material is configured to contact the surface along a substantial length of the surface between the support members.

9. The safety net support system of claim 8, wherein the material is a netting having at least a first mesh pattern and a second mesh pattern, wherein the second mesh pattern has a smaller mesh interval than the first mesh pattern and is configured in the material to contact the surface.

10. The safety net support system of claim 1, wherein the anchorage member further comprises a pressure level monitoring system that monitors a pressure level between the sealing member and the surface and automatically activates when the pressure level rises above a predetermined pressure level to vacate a gas between the sealing member and the surface to return the pressure level to below the predetermined pressure level.

11. The safety net support system of claim 10, wherein the pressure level monitoring system further comprises an alarm configured to activate when the pressure level rises above the predetermined pressure level and deactivate when the pressure level is reduced below the predetermined pressure level.

12. The safety net support system of claim 1, wherein the anchorage member of each of the plurality of support members is connected in pneumatic series to a single source of pressurized air.

13. The safety net support system of claim 1, wherein the surface is an aircraft surface.

14. A pneumatically-powered vacuum anchor comprising:
a pressurized air connector configured to receive a positive compressed air supply;
a control input operably coupled to the air supply, the control input having a first operating position and a second operating position, the control input being biased in the first operating position;
a pneumatic sealing member operably coupled to the air supply, the pneumatic sealing member being configured to transition between an engaged state and a disengaged state,
a vacuum generator operably coupled to the control input and configured to receive the air supply with the control input in the first operating position, the vacuum generator configured to place the pneumatic sealing member in the engaged state;
a release valve operably coupled to the control input and configured to receive the air supply with the control input in the second operating position, the release valve configured to place the pneumatic sealing member in the disengaged state;
wherein in the engaged state the sealing member is pneumatically coupled to a surface in contact therewith, and in the disengaged state the pneumatic sealing member is disengaged from the surface.

15. The pneumatically-powered vacuum anchor of claim 14, wherein with the control input in the second position the air supply is continuously introduced between the pneumatic sealing member and the surface to create an air cushion therebetween.

16. The pneumatically-powered vacuum anchor of claim 14, further comprising a pressure level monitoring system that monitors a pressure level between the sealing member and the surface, the pressure level monitoring system being configured to automatically activate when the pressure level rises above a predetermined level and vacate a gas between the sealing member and the surface to return the pressure level to below the predetermined level.

17. The pneumatically-powered vacuum anchor of claim 16, further comprising an alarm configured to activate when the pressure level rises above the predetermined level and deactivate when the pressure level is reduced below the predetermined level.

18. The pneumatically-powered vacuum anchor of claim 14, wherein the pressurized air connector is configured to connect in pneumatic series.

19. A method of setting a safety net support system, the method comprising:
providing a plurality of support members on a surface;
detachably coupling a barrier between the plurality of support members;
extending the barrier between the plurality of support members such that the barrier contacts the surface and rises a length above the surface;
pneumatically coupling the plurality of support members to the surface;
monitoring the pneumatic coupling; and
automatically maintaining the pneumatic coupling.

20. The method of claim 19, further comprising actuating a control switch to continuously introduce pressurized air between the support member and the surface, and releasing the control switch to pneumatically recouple the support member to the surface.
